(19) United States
(12) Patent Application Publication
(10) Pub. No.: US 2010/0065671 A1
(43) Pub. Date: Mar. 18, 2010

(54) RECORDING TAPE CARTRIDGE

(75) Inventor: Shozo ONMORI, Kanagawa (JP)

Correspondence Address: Solaris Intellectual Property Group, PLLC, 401 Holland Lane, Suite 407, Alexandria, VA, 22314, US

(73) Assignee: FUJIFILM CORPORATION, Tokyo (JP)

(21) Appl. No.: 12/541,186

(22) Filed: Aug. 14, 2009

(30) Foreign Application Priority Data
Sep. 18, 2008 (JP) 2008-239489

(51) Int. Cl. G11B 23/107

(52) U.S. Cl. 242/348

(57) ABSTRACT

A recording tape cartridge is equipped with a reel around which is wound recording tape and an upper case and a lower case that house the reel. Ribs whose rib height gradually becomes lower from a center side of the reel toward an outer peripheral side of the reel are formed on an inner surface of the upper case. Edge portions that slant linearly from the center side of the reel toward the outer peripheral side of the reel are formed on the reel side of the ribs. The distance of the space inside the case in the thickness direction of the recording tape cartridge is wider on the outer peripheral side of the reel in comparison to the center side of the reel, so it is difficult for the recording tape inside the case to sustain damage even if the recording tape cartridge receives an impact.

### CROSS-REFERENCE TO RELATED APPLICATION

This application claims priority under 35 USC 119 from Japanese Patent Application No. 2008-239489 filed on Sep. 18, 2008, the disclosure of which is incorporated by reference herein.

### BACKGROUND OF THE INVENTION

1. Field of the Invention

The present invention relates to a recording tape cartridge in which is rotatably housed a reel onto which is wound recording tape such as magnetic tape.

2. Description of the Related Art

Recording tape such as magnetic tape is used as an external recording medium for computers and the like. For this recording tape, there is employed a so-called one-reel recording tape cartridge that includes a case in which is rotatably housed a single reel onto which is wound recording tape whose housing space during storage is small and which can record a large quantity of information (e.g., see Japanese Patent Application Laid-Open Publications (JP-A) Nos. 2004-95068 and 5-242633).

In this recording tape cartridge, the case comprises an upper case and a lower case that are joined together in a state where peripheral walls of the upper case and the lower case have been brought into contact with each other. The reel comprises a reel hub and flanges that are respectively disposed on both axial direction ends of the reel hub, and the recording tape is wound onto the reel hub. When the reel is not in use, the reel is housed inside the case in a state where the reel is pushed against the lower case by the energizing force of a coil spring or the like. Further, a gear opening for exposing a reel gear formed on an axial direction lower end surface of the reel is disposed in the lower case.

Then, when the recording tape cartridge is to be used, the recording tape cartridge is loaded into a drive device, a drive gear of the drive device meshes with the reel gear and causes the reel to float inside the case counter to the above-described energizing force, and the drive gear is driven to rotate, whereby the reel is caused to rotate without contacting the inner surface of the case. Thus, the recording tape is wound out or rewound through an opening in the case for pulling out the recording tape, so that information can be recorded on the recording tape or information recorded on the recording tape can be reproduced.

In this connection, in this conventional recording tape cartridge, the reel is configured to be movable (floatable and returnable) in the up-and-down direction inside the case. For this reason, for example, when a user inadvertently drops the recording tape cartridge, it is conceivable for the reel to slant inside the case because of the impact force applied to the recording tape cartridge and for the impact force of the drop to become concentrated in the outer peripheral portions of the reel flanges, which easily deform as a result of moving away from their hub attachment positions. Because of this concentration of the impact force, it is conceivable for the outer peripheral portions of the reel flanges to deform toward the tape or undergo deformation where the distance between the reel flanges becoming shorter at the outer peripheral portions of the reel flanges, so that damage such as so-called tape edge bending or the like occurs at the width direction edge portions of the recording tape that are adjacent to the outer peripheral portions of the reel flanges. It is also conceivable for the same thing to occur in a two-reel recording tape cartridge.

### SUMMARY OF THE INVENTION

In view of the above-described circumstance, the present invention provides a recording tape cartridge where it is difficult for the recording tape inside the case to sustain damage even when the recording tape cartridge receives an impact.

A recording tape cartridge of a first aspect of the invention includes: a reel around which is wound recording tape; and a case that houses the reel, wherein ribs whose rib height gradually becomes lower from a center side of the reel toward an outer peripheral side of the reel are formed on at least one of mutually opposing inner surfaces of the case.

The ribs may be configured by plural members or by one member with which these members are integrally continuous.

In the recording tape cartridge of the first aspect of the invention, the above-described ribs are disposed, so the distance of the space inside the case in the thickness direction of the recording tape cartridge is wider on the outer peripheral side of the reel in comparison to the center side of the reel. Consequently, even when an impact resulting from a drop or the like is applied to the recording tape cartridge, a situation where a load becomes concentrated in the outer peripheral portions of the reel flanges such that the outer peripheral portions of the reel flanges deform toward the tape or undergo deformation where the distance between the reel flanges becomes shorter is avoided. Consequently, even when such an impact is applied to the recording tape cartridge, it is difficult for the width direction edge portions (tape edge portions) of the recording tape to sustain damage.

In the recording tape cartridge of the first aspect of the invention, the case may be configured by an upper case and a lower case, and the ribs may be formed on the upper case.

In terms of the structure of the recording tape cartridge, it is easy for the reel to undergo deformation where the reel slants toward the upper case when the recording tape cartridge is dropped. Consequently, according to the above-described configuration, damage to the width direction edge portions of the recording tape can be more effectively prevented.

In the recording tape cartridge of the first aspect of the invention, the ribs may be configured by plural unit ribs that extend radially from the center side of the reel. Thus, the strength of the case can be raised by the ribs, and the configuration of the ribs can be simplified.

In the recording tape cartridge of the first aspect of the invention, edge portions that slant linearly from the center side of the reel toward the outer peripheral side of the reel may be formed on the reel side of the unit ribs.

According to the above-described configuration, when the reel deforms so as to slant such that the reel flanges contact the unit ribs, the reel flanges line-contact the unit ribs. Consequently, a situation where the impact force of a drop becomes concentrated in the outer peripheral portions of the reel flanges, which easily deform as a result of moving away from their hub attachment positions, is prevented even more, and a situation where a partially large load is applied to the reel flanges such that the tape edge portions sustain damage is reliably prevented.

In the recording tape cartridge of the first aspect of the invention, angles formed by the unit ribs that are mutually adjacent may be configured to be equal. According to this configuration, the aforementioned effect is obtained equally across the entire circumferences of the reel flanges.

According to the present invention, there can be obtained a recording tape cartridge where it is difficult for the recording tape inside the case to sustain damage even when the recording tape cartridge receives an impact.

### BRIEF DESCRIPTION OF THE DRAWINGS

FIG. 1 is a general perspective view of a recording tape cartridge pertaining to an embodiment of the present invention;

FIG. 2 is a general exploded perspective view of the recording tape cartridge pertaining to the embodiment of the present invention;

FIG. 3 is a partially enlarged perspective view showing an upper case of the recording tape cartridge pertaining to the embodiment of the present invention in a state where the upper case has been inverted;

FIG. 4 is a partial side sectional view (where illustration of recording tape is omitted) showing a state where the recording tape cartridge pertaining to the embodiment of the present invention has not received an impact; and

FIG. 5 is a partial side sectional view (where illustration of recording tape is omitted) showing a state where the recording tape cartridge pertaining to the embodiment of the present invention has received an impact.

### DETAILED DESCRIPTION OF THE INVENTION

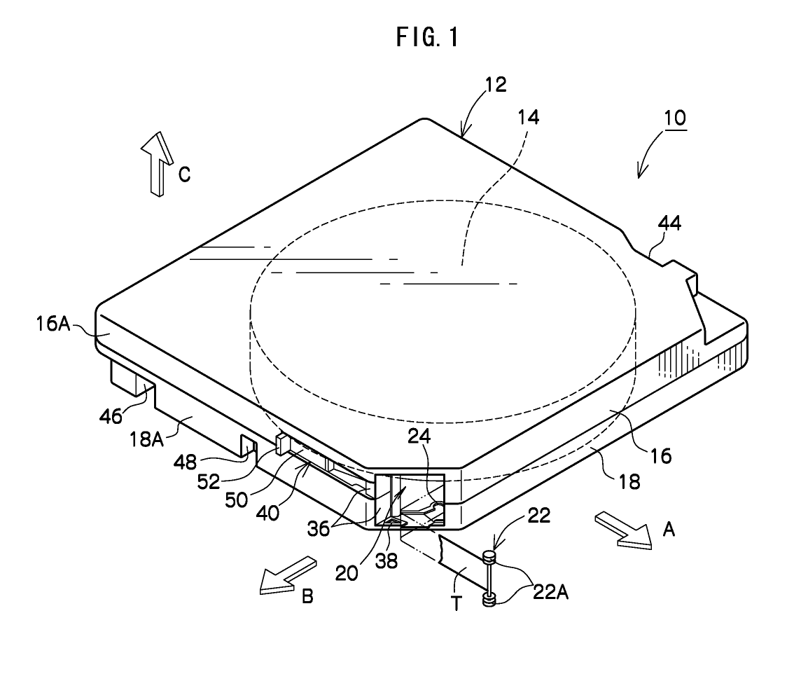

Below, the best mode for implementing the present invention will be described in detail on the basis of an embodiment shown in the drawings. For the sake of convenience of description, in FIG. 1, arrow A represents the direction in which a recording tape cartridge 10 is loaded into a drive device (not shown) and will be referred to as a front direction (front side) of the recording tape cartridge 10. Additionally, the direction of arrow B, which is orthogonal to arrow A, will be referred to as a right direction (right side). Further, arrow C represents a direction that is orthogonal to the direction of arrow A and the direction of arrow B and will be referred to as an upper direction (upper side) of the recording tape cartridge 10.

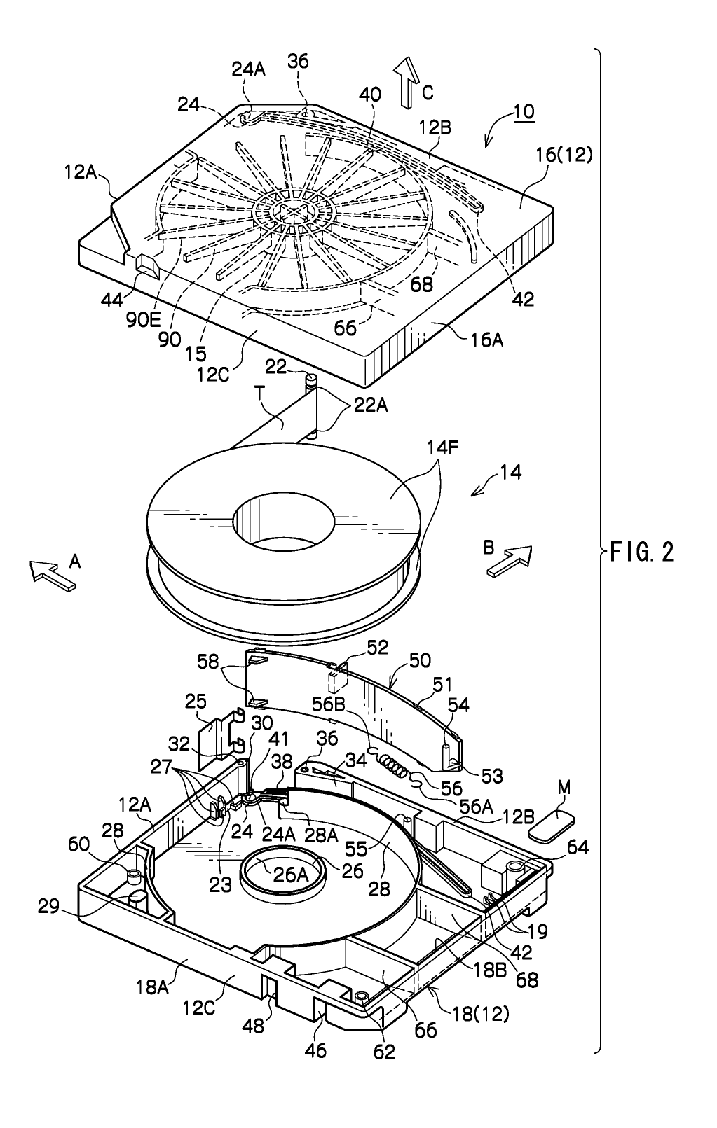

As shown in FIG. 1 and FIG. 2, the recording tape cartridge 10 is configured such that a reel 14, onto which is wound recording tape T such as magnetic tape that is an information recording and reproducing medium, is rotatably and singly housed inside a case 12 that is configured to have a substantially rectangular shape when seen in a planar view. The case 12 is configured by joining together an upper case 16 and a lower case 18 in a state where a peripheral wall 16A of the upper case 16 and a peripheral wall 18A of the lower case 18 have been brought into contact with each other. Right front corner portions of the upper case 16 and the lower case 18, which configure one corner portion of the case 12 on a leading side in the direction in which the recording tape cartridge 10 is loaded into the drive device, are cut away diagonally when seen in a planar view. A housing space that houses the reel 14 is formed inside the case 12.

Further, the cutout corner portions of the peripheral walls 16A and 18A of the upper case 16 and the lower case 18 are configured as an opening 20 for pulling out the recording tape T, and a leader pin 22 that is locked (engaged) and pulled out by pullout means (not shown) of the drive device is connected to a free end of the recording tape T that is pulled out from the opening 20. Annular grooves 22A are formed in both end portions of the leader pin 22 that project from the width direction edge portions of the recording tape T, and hooks or the like of the pullout means lock into the annular grooves 22A. Thus, the hooks or the like do not contact and damage the recording tape T when the pullout means pulls out the recording tape T.

Further, a pair of upper and lower pin holding portions 24 that position and hold the leader pin 22 inside the case 12 are disposed inside the opening 20 in the case 12. The pin holding portions 24 have substantially semicylindrical shapes and are configured such that both end portions of the leader pin 22 in an upright state are held inside recessed portions 24A of the pin holding portions 24. It will be noted that the recording tape T pullout sides of the pin holding portions 24 are open and serve as entries and exits that the leader pin 22 enters and from which the leader pin 22 exits.

Further, a plate spring 25 is fixedly disposed in the vicinity of the pin holding portions 24 as a result of its base portion being inserted into groove portions 23 and spring holding portions 27 that are disposed in the inner surface of a front wall 12A (portions of the outer surfaces of the peripheral walls 16A and 18A that face the direction of arrow A). A two-pronged distal end portion of the plate spring 25 is configured to engage with the upper and lower ends of the leader pin 22 and hold the leader pin 22 in the pin holding portions 24. It will be noted that the distal end portion of the plate spring 25 is configured to appropriately elastically deform to allow movement of the leader pin 22 when the leader pin 22 enters and exits the pin holding portions 24.

Moreover, a gear opening 26 for exposing a reel gear (not shown) of the reel 14 to the outside is disposed in the center portion of the lower case 18, and the reel 14 is driven to rotate inside the case 12 as a result of the reel gear meshing with a drive gear (not shown) of the drive device. Further, the area in which the reel 14 is housed is defined by a (planar view substantially circular arc-shaped) play regulating wall (regulating wall) 28 that is respectively partially disposed on, so as to project from, the inner surfaces of the upper case 16 and the lower case 18 and is on a circular locus (on a circumference) that is coaxial with the gear opening 26. Additionally, the reel 14 is housed on the inner side of the play regulating wall 28 and is held so as to not rattle.

Further, an annular rib 26A is disposed on the edge portion of the gear opening 26 in the lower case 18 so as to project inside the case 12, and the annular rib 26A is configured to be for positioning the reel 14. Moreover, a brake portion that includes an annular rib 15 in a position facing the annular rib 26A is disposed on the upper case 16 so as to face inside the case 12.

Further, in the lower case 18, a pocket portion 28A, inside of which is formed a position regulating hole, is disposed consecutively with the end portion of the play regulating wall 28 in the vicinity of the opening 20. On the inner side of the left front corner portion of the lower case 18, a pocket portion 29, inside of which is formed a position regulating hole that is an elongate hole, is disposed away from the play regulating wall 28. The pocket portions 28A and 29 are disposed on a straight line along the direction of arrow B, and areas around the position regulating holes on the undersurface side of the lower case 18 (portions that have the same thickness as, or are slightly wider than, the pocket portions 28A and 29) are configured as reference surfaces for positioning with respect to the drive device.

Additionally, the play regulating wall 28 of the lower case 18 partitions the inside of the case 12 into areas on the outer side of the play regulating wall 28 and the housing area (housing space) of the reel 14 as a result of its end portions, excluding the end portion where the pocket portion 28A is consecutively disposed, being disposed consecutively with the peripheral wall 18A. Further, the play regulating wall 28 of the upper case 16 also similarly (in vertical symmetry) partitions the inside of the case 12 into areas on the outer side of the play regulating wall 28 and the housing area (housing space) of the reel 14 as a result of its end portions being disposed consecutively with the peripheral wall 16A. Thus, the strength of the case 12 can be improved, and the dust-prooffiess of the housing area of the reel 14 can be improved.

Further, the outer peripheral surface of the play regulating wall 28 of the lower case 18 on the rear side of the case 12 and the peripheral wall 18B are integrally interconnected by connecting ribs 66 and 68. The connecting ribs 66 and 68 are both formed in flat plate shapes whose longitudinal direction is in the front-rear direction of the case 12, and the connecting rib 66 and the connecting rib 68 are formed a predetermined distance away from each other in the left-right direction (in bilateral symmetry). It will be noted that the connecting ribs 66 and 68 are also similarly (in vertical symmetry) formed on the upper case 16.

Further, a screw boss 60 that forms a vertical pair with a screw boss 60 on the upper case 16 is disposed in a predetermined position between the front wall 12A and the play regulating wall 28 on the side where the pocket portion 29 is disposed, and screw bosses 62 and 64 that form vertical pairs with screw bosses 62 and 64 on the upper case 16 are also disposed in predetermined positions in both corner portions between both the left and right end portions of a rear portion inner surface 18B of the lower case 18 and a left wall 12C and a right wall 12B. The vertical pairs of screw bosses 60, 62 and 64 penetrate the lower case 18 but do not penetrate the upper case 16.

Further, a pair of upper and lower short slanted wall portions 30 that define the front edge portion of the opening 20 are disposed on the right end portion of the front wall 12A of the case 12. The slanted wall portions 30 are formed so as to bend along the open surface of the opening 20 and become dust-proof walls to ensure that a gap through which dust or the like can ingress does not arise when the leading end of a later-described planar view substantially circular arc-shaped door 50 enters the inner sides of the slanted wall portions 30 when the door 50 closes off the opening 20. Additionally, a pair of upper and lower screw bosses 32 are disposed consecutively with the inner side of the front wall 12A in the vicinity of the left sides of the slanted wall portions 30.

Further, a pair of upper and lower slanted wall portions 34 that have shapes that substantially follow the outer peripheral surface of the later-described door 50 when seen in a planar view are disposed on the inner side of the front end portion of the right wall 12B (portions of the outer surfaces of the peripheral walls 16A and 18A that face the direction of arrow B) of the case 12. The front end surfaces of the slanted wall portions 34 define the rear edge of the opening 20, and a pair of upper and lower screw bosses 36 are disposed in the front end portions thereof.

Further, a slit 40 with a predetermined length that serves as a window portion that allows the inside and the outside of the case 12 to be communicated with each other is disposed in the right wall 12B of the case 12, and the slit 40 is configured to be for exposing an operation projection 52 of the later-described door 50. The slit 40 is formed by cutting away the front side lower portion of the peripheral wall 16A of the upper case 16 that configures the right wall 12B, and the slit 40 opens toward the opening 20. It is preferable for the slit 40 to be formed such that some of the peripheral wall 16A remains on the upper side of the slit 40 in this manner, because the rigidity of the case 12 can be maintained. It is particularly preferable for the wall on the upper side that defines the slit 40 to be integrally disposed consecutively from the slanted wall portion 34.

Further, a recessed portion 48 whose portion excluding the upper end of the peripheral wall 18A is recessed inward of the case 12 and is also recessed upward from the undersurface of the case 12 (the bottom plate is cut away) in a cross-sectional view substantial “U” shape is formed toward the rear side of the lower case 18. The recessed portion 48 is, for example, configured as an engagement portion with which pull-in means (not shown) of the drive device engages, and the bottom surface (the surface that faces down) of the recessed portion 48 is configured as a reference surface for positioning inside the drive device.

Further, a recessed portion 46 whose portion excluding the upper end of the peripheral wall 18A is recessed inward of the case 12 and is also recessed upward from the undersurface of the case 12 (the bottom plate is cut away) in a cross-sectional view substantial “U” shape is also formed on the rear side of the recessed portion 48. The recessed portion 46 is, for example, configured as an engagement portion with which gripping means (not shown) of a library device engages, and the torsional strength of the case 12 (the lower case 18) is improved by disposing the recessed portions 46 and 48.

Further, a planar view substantially trapezoidal recessed portion 44 is formed in the upper surface portion of the left wall of the upper case 16. The recessed portion 44 is configured as an engagement portion with which a holding member (not shown) that is disposed in the drive device engages in order to cancel the rotational moment that accompanies movement in the opening direction of the door 50 when the door 50 opens the opening 20.

Further, guide wall portions 42 with a predetermined height (e.g., a height of about 1.0 mm to about 1.5 mm) that support tongue portions 51 of the later-described door 50 so as to sandwich the tongue portions 51 from both their inner surface sides and their outer surface sides are disposed upright on the upper case 16 and on the lower case 18 from the vicinity of the opening 20 to the vicinity of the site where the play regulating wall 28 comes closest to the right wall 12B (called “front halves” below) and from the vicinity of the rear end of the slit 40 to the vicinity of the rear wall (called “rear halves” below).

The lengths of the guide wall portions 42 differ between the upper case 16 and the lower case 18, with the rear half of the guide wall portion 42 of the upper case 16 being longer than the rear half of the guide wall portion 42 of the lower case 18. This is because a later-described memory board M is disposed on the right wall 12B side of the rear portion inner surface 18B of the lower case 18. Further, the rear end portions of the rear halves of the guide wall portions 42 are closed off in planar view substantially circular arc shapes and respectively regulate the rearmost tongue portions 51 on the top and bottom of the door 50 such that the door 50 cannot move any further rearward.

The front end portions of the front halves of the guide wall portions 42 are open, and the front halves of the guide wall portions 42 are disposed so as to extend as far as positions where they do not hinder the entering and exiting of the leader pin 22 when the leader pin 22 enters and exits (the positions shown in the drawings are on the rear side of the pin holding portions 24 and are about half of the opening width of the opening 20). Further, guide wall portions 41 whose rear end portions are open are also disposed upright in the vicinity of the slanted wall portions 30 so as to be positioned on extension lines of the guide wall portions 42. The guide wall portions 41 are configured to not extend rearward beyond the front ends of the pin holding portions 24 so that the rear end portions of the guide wall portions 41 do not hinder the entering and exiting of the leader pin 22, and the door 50 is configured to close off the opening 20 in a state where the leading end of the door 50 has entered the guide wall portions 41.

Further, the guide wall portions 41 and the front halves of the guide wall portions 42 are formed so as to be slightly lower than the rear halves of the guide wall portions 42. That is, for example, the height of the guide wall portions 41 and the front halves of the guide wall portions 42 is formed to be about 1 mm, and the height of the rear halves of the guide wall portions 42 is formed to be about 1.5 mm. This is to ensure space for the pullout means that is disposed in the drive device to enter the opening 20. Consequently, as described later, the plate width (height) of the front half portion of the door 50 (at least the portion that closes off the opening 20) is formed so as to be larger (higher) in correspondence to the guide wall portions 41 and the front halves of the guide wall portions 42 being low.

Moreover, ribs 38 that are integrated with the outer side guide wall portions 42 exposed from the opening 20 and have planar view substantially trapezoidal shapes are disposed upright on the inner surface of the upper case 16 and on the inner surface of the lower case 18 so as to become the same height as the guide wall portions 42, and the strength of the upper case 16 and the lower case 18 at the portion of the opening 20 is ensured by the ribs 38. It will be noted that, although the inner side guide wall portions 42 are disposed consecutively so as to become integrated with the pin holding portions 24, it is desirable for the height of the pin holding portions 24 to be formed at substantially the same height or higher than the height of the guide wall portions 42 that are integrally consecutively disposed.

The upper case 16 and the lower case 18 that have been described above are fixed Ooined together) as a result of unillustrated screws being screwed from below into the screw bosses 32 and 36 that are positioned in the vicinity of the edge portions of the opening 20 and into the above-described screw bosses 60, 62 and 64. Thus, the corner portions of both ends of the opening 20, which are defined particularly by the free ends of the slanted wall portions 30 (the front wall 12A) and the slanted wall portions 34 (the right wall 12B) and which are disadvantaged in terms of strength and which easily impact with the ground or the like as a result of the case 12 being dropped, are strongly joined together so that, even if the case 12 is dropped, the corner portions of both ends of the opening 20 do not deform, buckle or shift positions under the weight of the entire recording tape cartridge 10.

Further, the opening 20 is configured to be opened and closed by the door 50 that serves as a shielding member. The plate width (height) of at least the portion of the door 50 that closes off the opening 20 is formed so as to be substantially the same as the opening height of the opening 20, the plate width (height) of the rear side of the door 50 is formed so as to be slightly smaller (lower), and the plate length of the door 50 is formed so as to be sufficiently larger than the opening width of the opening 20. Additionally, the door 50 is formed in a planar view substantially circular arc shape that is curved in its plate thickness direction such that the door 50 can move along a predetermined circumference.

The door 50 is configured to close off the opening 20 in a state where the leading end portion of the door 50 has entered the guide wall portions 41, slide (rotate) substantially rearward along the predetermined circumference to open the opening 20, and completely open the opening 20 when the outer peripheral surface in the vicinity of the leading end of the door 50 reaches the vicinity of the screw bosses 36. Additionally, the door is configured to close off the opening 20 by sliding (rotating) in the opposite direction of the direction when the door 50 opens the opening 20.

In this manner, the door 50 is formed so as to curve in a circular arc shape that corresponds to the predetermined circumference that is the movement locus of the door 50, and the center of rotation of the door 50 is, in the present embodiment, set such that its position in the left-right direction is in the vicinity of the left end of the case 12 and such that its position in the front-rear direction is in the vicinity of the rear end of the slit 40. Thus, the movement locus of the door 50 comes closest to the right wall 12B of the case 12 in the vicinity of the rear end of the slit 40. It will be noted that it suffices for the rotational center and the radius of the door 50 to be determined in response to the positions of the front and rear edge portions (the slanted wall portions 30 and the screw bosses 36) of the opening 20 that are determined by demand from the drive device and the angle of the open surface of the opening 20 that is determined by demand from the library device.

Further, the curved longitudinal dimension of the door 50 is determined such that the rear end portion of the door 50 is positioned inside the right rear corner portion of the case 12 behind the recessed portion 48 (in the vicinity of the recessed portion 46) in a state where the opening 20 is closed off, and the rear lower portion of the door 50 is diagonally cut away in order to avoid the memory board M that is disposed slanting at a predetermined angle θ by later-described position regulating ribs 19. It will be noted that it is preferable for at least one of the inner surface and the outer surface of the front end portion of the door 50 to be formed as a tapered surface so that the door can smoothly enter between the guide wall portions 41.

Further, the tongue portions 51, which respectively contact guide surfaces (inner surfaces that face each other) of the guide wall portions 42 and the inner surface of the upper case 16 and the inner surface of the lower case 18 between the guide wall portions 42 and guide the door 50 in the directions in which the door 50 opens and closes the opening 20, are disposed on, so as to project from, the upper surface and the lower surface of the door 50. The tongue portions 51 are formed in planar view substantially elliptical shapes that are long along the longitudinal direction of the door 50, and the tongue portions 51 are disposed on, so as to project from, the upper surface and the lower surface of the door 50 such that there are four of the tongue portions 51 each on the upper surface and the lower surface of the door 50 in vertical symmetry excluding the rearmost tongue portions 51 and such that the tongue portions 51 become substantially the same height as the height of the guide wall portions 42 (e.g., the height of the tongue portions 51 on the front side of the boundary portion where the plate widths of the door 50 differ is about 0.5 mm, and the height of the tongue portions 51 on the rear side of the boundary portion where the plate widths of the door 50 differ is about 1.5 mm). It will be noted that the reason why the rearmost tongue portions 51 are not in vertical symmetry is because the rear lower portion of the door 50 is diagonally cut away.

When the tongue portions 51 are disposed, sliding resistance (friction) between the door 50 and the inner surface of the upper case 16 and the inner surface of the lower case 18 between the guide wall portions 41 and the guide wall portions 42 and also between the door 50 and the guide surfaces of the guide wall portions 41 and the guide wall portions 42 can be reduced, and it becomes possible to allow the door 50 to slide smoothly with little resistance. Moreover, when the tongue portions 51 are formed in planar view substantially elliptical shapes, the tongue portions 51 have much better impact-resistance than when, for example, the tongue portions 51 are formed in planar view substantially circular shapes. Consequently, there is no fear that the tongue portions 51 will break even when a force is applied to the door 50 from a direction other than the opening and closing direction due to an impact such as a drop.

Further, the operation projection 52 that serves as an operation portion is disposed on, so as to project along the radial direction of the door 50 from, the outer peripheral surface of the door 50 slightly in front of the longitudinal direction center portion of the door 50 (in the vicinity of the boundary portion where the plate widths of the door 50 differ). The operation projection 52 is configured to be exposed to the outer side of the case 12 from the slit 40, is positioned slightly away from the rear ends of the screw bosses 36 in a state where the opening 20 is closed off, and is configured to be operable from the portion of the slit 40 that opens frontward.

Additionally, in a state where the opening 20 is open, the operation projection 52 is positioned slightly away from the rear edge of the slit 40, and, at this time, the rearmost tongue portions 51 contact the closed-off rear end portions of the guide wall portions 42. It will be noted that, although the inside and the outside of the case 12 are communicated with each other by the slit 40 for exposing the operation projection 52, the slit 40 is always substantially closed off by the screw bosses 36 and the door 50 that spans substantially the entire height of the inside of the case 12, and the play regulating wall 28 that serves as an inner wall is disposed inside the case 12, so the adhesion of dust or the like to the recording tape T that is wound onto the reel 14 is prevented.

Further, stoppers 58 that contact the side surface of the upper end portion and the side surface of the lower end portion of the leader pin 22 when the door 50 closes off the opening 20 are disposed on, so as to project from, the inner surface of the front end portion of the door 50, and thus the leader pin 22 can be prevented even more from coming out of the pin holding portions 24 because of a drop impact or the like. Additionally, a coil spring 56 that serves as an energizing member that energizes the door 50 in the direction in which the door 50 closes off the opening 20 is disposed effectively utilizing the space in the right rear corner portion of the case 12 between the play regulating wall 28 and the right wall 12B (the peripheral walls 16A and 18A) because the door 50 has a length that extends to the right rear corner portion of the case 12 in a state where the opening 20 is closed off.

That is, a plate-shaped support portion 53 is integrally disposed on, so as to be consecutive with, the inner peripheral surface of the door 50 in the vicinity of the rear end of the door 50, a spring holding portion 54 is integrally disposed on, so as to project upward from, the upper surface of the support portion 53, and a cylindrical spring locking portion 55 is disposed on, so as to project upward from, the inner surface of the lower case 18 in the vicinity of the recessed portion 48. Additionally, ring-shaped attachment portions 56A and 56B are respectively formed on both ends of the coil spring 56. Consequently, the coil spring 56 can be easily attached inside the above-described space by inserting the one attachment portion 56B from above over the spring locking portion 55 and inserting the other attachment portion 56A from above over the spring holding portion 54.

Further, a rib 57, which the upper end of the spring holding portion 54 slidingly contacts when the door 50 opens and closes, is disposed upright in a planar view substantially circular arc shape on the inner surface of the upper case 16. The rib 57 is disposed in a position and with a length such that the upper end of the spring holding portion 54 can slidingly contact the rib 57 at least when the door 50 begins to move (open), and the rib 57 ensures that the door 50 is more stably opened by suitably guiding the spring holding portion 54 that moves counter to the energizing force of the coil spring 56 (so that the door 50 does not shake due to the energizing force of the coil spring 56 when the door 50 opens).

Further, by disposing the rib 57, it can be ensured that the attachment portion 56A of the coil spring 56 that has been attached as described above does not come off of the spring holding portion 54 even when an impact resulting from a drop or the like is applied to the case 12 and raises the spring holding portion 54. It will be noted that the upper end of the spring locking portion 55 also becomes inserted between the play regulating wall 28 and the guide wall portion 42 of the upper case 16, so the attachment portion 56B can be similarly prevented from coming off of the spring locking portion 55.

Further, the memory board M, in which various information such as the recording capacity and the recording format is recorded and which is accessible without contact, is disposed slanting at the predetermined angle θ (e.g., θ=45°) in the right rear portion of the lower case 18. That is, the rear portion inner surface 18B of the lower case 18 slants at the predetermined angle θ, and a plurality (e.g., two) of position regulating ribs 19 are disposed a predetermined distance away from each other in the left-right direction on, so as to project from, the inner surface of the lower case 18 in front of the rear portion inner surface 18B and in back of the regulating wall 28.

Consequently, the memory board M is disposed on the rear portion inner surface 18B, and the lower end portion of the memory board M is supported by the position regulating ribs 19, whereby the memory board M is held (so as to not slip and fall) in an orientation where the memory board M slants at the predetermined angle θ. It will be noted that it is preferable for the slanting angle θ of the rear portion inner surface 18B to be set to 45° in order to enable access from the undersurface side and the rear surface side of the case 12 with respect to the memory board M.

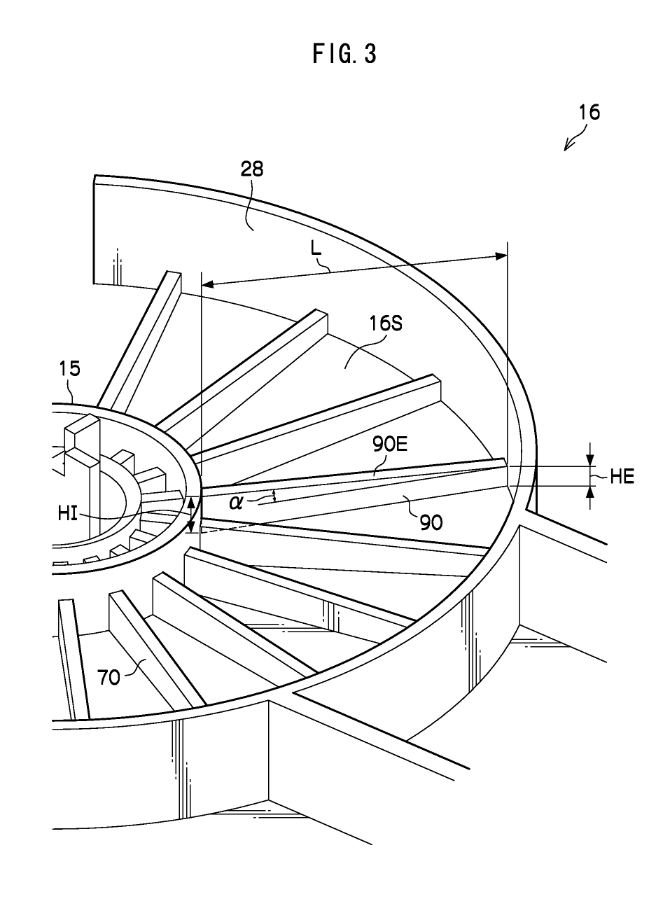

Further, as shown in FIG. 2 and FIG. 3, plural unit ribs 90 that are tabular, elongate and extend outward from the center side of the reel 14 are formed on the inner surface of the upper case 16.

The plural unit ribs 90 are disposed radially coaxially with the annular rib 15 (that is, the reel 14) and equidistantly. That is, angles formed between the unit ribs 90 that are mutually adjacent are configured to be constant. In the present embodiment, there are eighteen of the unit ribs 90. That is, the unit ribs 90 are disposed every 20° (=θ).

The base ends of the unit ribs 90 are disposed so as to be continuous with the annular rib 15, and the terminal ends of the unit ribs 90 are disposed so as to be continuous with the play regulating wall 28 or to be on a hypothetical extension line of the play regulating wall 28. That is, the length of each of the unit ribs 90 is configured to equal to the difference between the radius of the play regulating wall 28 and the radius of the annular rib 15. Further, the height of each of the unit ribs 90 is lower than the height of the annular rib 15 (see FIG. 3).

Additionally, the rib height of each of the unit ribs 90 is lower on the outer peripheral side of the reel 14 than on the center side of the reel 14, and edge portions 90E on the reel side of the unit ribs 90 slant linearly from the center side of the reel 14 toward the outer peripheral side of the reel 14.

In the present embodiment, as shown in FIG. 3, a slanting angle a of the edge portions 90E with respect to an inner surface 16S of the upper case 16 is set to a maximum of 2°. Here, α is determined by a rib length L along the inner surface 16S of the upper case 16 and by a difference dh between a rib height HI of the unit ribs 90 on the center side of the reel 14 and a rib height HE of the unit ribs 90 on the outer peripheral side of the reel 14. As examples of these dimensions, the rib length L is in the range of 28 to 30 mm, and the difference dh between the rib height HI and the rib height HE is 1.0 mm.

(Action and Effects)

Next, the action of the recording tape cartridge 10 of the above configuration will be described. When the recording tape cartridge 10 of the above-described configuration is not in use (during storage, during transport), the opening 20 is closed off by the door 50. Specifically, the door 50 is always energized by the energizing force of the coil spring 56 in the direction in which the door 50 closes off the opening 20, and the door 50 closes off the opening 20 in a state where the leading end portion (front end portion) of the door 50 enters the guide wall portions 41 in the vicinity of the slanted wall portions 30.

A plurality of the recording tape cartridges 10 are housed in this state in a library device. Then, a reading and writing device that is disposed in an unillustrated robot hand accesses the memory boards M from the rear surface (rear wall) sides of the recording tape cartridges 10, reads the various information such as the recording capacity that is stored in the memory boards M, and transmits that information to a control device (not shown). Thus, drive devices that are most suitable to the recording tape cartridges 10 (capable of recording information to and reproducing information from the recording tape cartridges 10) are recognized beforehand by the control device.

Then, when the recording tape T is to be used, one of the recording tape cartridges 10 is taken out from the library device by the robot hand, and that recording tape cartridge 10 is loaded into a drive device along the direction of arrow A. This drive device is a drive device that has been selected as a result of the information stored in the memory board M having been read, and the recording tape cartridge 10 is loaded into the drive device smoothly and efficiently by the robot hand. Then, in accompaniment with this loading, an opening and closing member (not shown) of the drive device enters the forwardly open slit 40 and engages with the operation projection 52 of the door 50.

In this state, when the recording tape cartridge 10 (the case 12) is pushed further in the direction of arrow A, the opening and closing member causes the operation projection 52 to move rearward counter to the energizing force of the coil spring 56 because of this pushing force (causes the operation projection 52 to move relatively rearward with respect to the case 12 that is loaded in the direction of arrow A). Then, the door 50 from which the operation projection 52 projects rotates in a clockwise direction when seen in a planar view along the curving direction thereof while the tongue portions 51 are guided by the guide wall portions 42.

That is, the door 50 moves substantially rearward, so as to move around the outer side of the pin holding portions 24 and the reel 14 without projecting out from the movement locus along the curving shape of the door 50 because of the guide wall portions 42, and opens the opening 20. Then, when the case 12 (the recording tape cartridge 10) is loaded a predetermined depth in the drive device, the opening 20 is completely opened, the recording tape cartridge 10 is positioned, and the reading and writing device that is disposed in the drive device accesses the memory board M from the undersurface side of the recording tape cartridge 10, reads the various information stored in the memory board M, and also writes individual information as needed.

When the recording tape cartridge 10 is positioned inside the drive device in a state where the opening 20 has been opened in this manner, further rotation (substantially rearward movement) of the door 50 is regulated, and the pullout means of the drive device enters the inside of the case 12 from the opened opening 20, extracts the leader pin 22 that is positioned and held in the pin holding portions 24, and houses the leader pin 22 in an unillustrated take-up reel. Then, the take-up reel and the reel 14 are driven to rotate synchronously, whereby the recording tape T is sequentially pulled out from the case 12 while being taken up on the take-up reel, and the recording and reproducing of information are performed by a recording and reproducing head (not shown) that is disposed along a predetermined tape path.

When the recording tape T is to be rewound onto the reel 14 and the recording tape cartridge 10 is to be ejected from the drive device, the positioned state of the recording tape cartridge 10 is released, and the recording tape cartridge 10 is moved in the opposite direction of the direction of arrow A by an unillustrated ejecting mechanism. Then, the door 50 is rotated by the energizing force of the coil spring 56 in the direction in which the door 50 closes off the opening 20 while the tongue portions 51 are guided by the guide wall portions 42. Then, the leading end portion of the door 50 enters the guide wall portions 41, whereby the opening 20 is completed closed off and returns to its initial state.

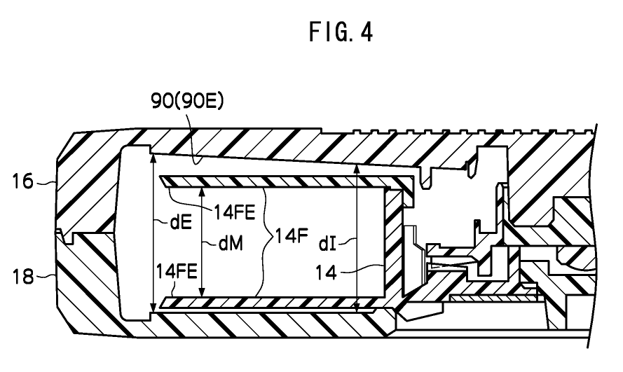

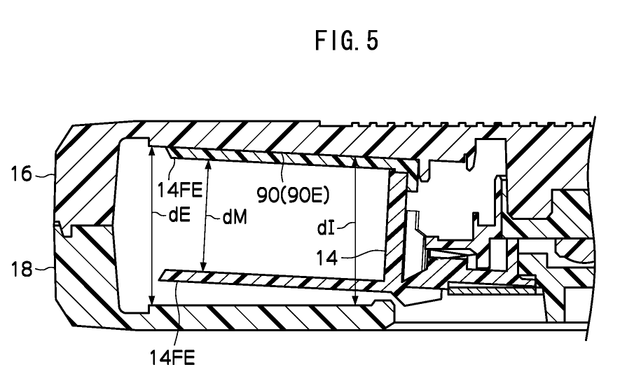

Further, as shown in FIG. 4, in the space inside the case 12, a distance dE on the outer peripheral side of the reel 14 in the thickness direction of the recording tape cartridge 10 is wider in comparison to a distance dI on the center side of the reel 14 in the thickness direction of the recording tape cartridge 10. Consequently, even if an inadvertent impact such as a drop is applied to the recording tape cartridge 10 and deformation force acts on the reel 14, as shown in FIG. 5, reel flanges 14F can undergo flexural deformation about an axis that is orthogonal to the axis of rotation of the reel 14 (that is, about an axis that is orthogonal to the page surface in FIG. 5) on the center side of the reel 14. Thus, a load does not become concentrated in reel flange outer peripheral portions 14FE, which easily deform as a result of moving away from their hub attachment positions, and deformation toward the tape at the reel flange outer peripheral portions 14E and deformation where a distance dM between the reel flanges 14F becomes shorter are avoided. Consequently, it is difficult for the width direction edge portions of the recording tape T to sustain damage even when such an impact force is applied to the recording tape cartridge 10.

Further, the edge portions 90E that slant linearly from the center side of the reel 14 toward the outer peripheral side of the reel 14 are formed on the reel side of the unit ribs 90. Thus, when the reel 14 deforms so as to slant and contacts the unit ribs 90, the reel flanges 14F line-contact the edge portions 90E. Consequently, a situation where the impact force of a drop becomes concentrated in the reel flange outer peripheral portions 14FE is prevented even more, and a situation where a partially large load is applied to the reel flanges 14F such that the tape edge portions sustain damage is reliably prevented. Additionally, the angles θ formed by the unit ribs 90 that are mutually adjacent are configured to be equal, so this effect can be achieved across the entire circumferences of the reel flanges 14F.

Further, in the present embodiment, the unit ribs 90 are formed on the upper case 16. In terms of the structure of the recording tape cartridge 10, when the impact of a drop is applied, the reel 14 easily undergoes slanting deformation toward the upper case 16, and thus damage to the width direction edge portions of the recording tape T can be more effectively prevented.

Moreover, the unit ribs 90 extend radially from the center side of the reel 14. Consequently, the strength of the case 12 rises because of the plural unit ribs 90, and the configuration of the ribs 90 is simple.

It will be noted that the present embodiment is only one example of the present invention and can be variously altered and implemented within a range that does not depart from the gist of the invention. For example, even when the unit ribs 90 are disposed on the lower case 18 rather than on the upper case 16, the reel flanges 14F can undergo flexural deformation about an axis that is orthogonal to the axis of rotation of the reel 14 on the center side of the reel 14, and the reel flanges F do not have to undergo deformation that shortens the distance dM between the reel flanges. Consequently, even when the impact force from a drop or the like is applied to the recording tape cartridge 10, it is difficult for the width direction edge portions of the recording tape T to sustain damage.

Moreover, the unit ribs 90 may also be formed on both the upper case 16 and the lower case 18. Thus, the above-described effect can be made even more remarkable.

Further, in the present embodiment, an example has been described where the unit ribs 90 extend radially from the annular rib 15, but the present invention is not limited to this; for example, ribs that extend spirally from the annular rib 15 may also be formed.

Further, in the present embodiment, an example has been described where the edge portions 90E of the unit ribs 90 slant linearly outward from the center side of the reel 14, but the edge portions 90E may also be configured to slant in a stepwise manner or in an undulating manner outward from the center side of the reel 14.

The door 50 also is not limited to a door that slides in a planar view substantially circular arc shape and may also be a door that slides linearly, for example.

Further, in the present embodiment, an example has been described where the recording tape cartridge is a so-called one-reel recording tape cartridge where a single reel is rotatably housed inside a case, but the same effects can be achieved even in a so-called two-reel recording tape cartridge where two reels are rotatably housed inside a case.

Moreover, it suffices as long as the recording tape T is understood to be an elongate tape-like information recording and reproducing medium that is capable of recording information and reproducing recorded information, and it goes without saying that the recording tape cartridge 10 is applicable to recording tape T of any recording and reproducing format.

What is claimed is:

1. A recording tape cartridge comprising:
a reel around which is wound recording tape; and
a case that houses the reel,
wherein ribs whose rib height gradually becomes lower from a center side of the reel toward an outer peripheral side of the reel are formed on at least one of mutually opposing inner surfaces of the case.

2. The recording tape cartridge according to claim 1, wherein the case is configured by an upper case and a lower case, and the ribs are formed on the upper case.

3. The recording tape cartridge according to claim 1, wherein the ribs are configured by plural unit ribs that extend radially from the center side of the reel.

4. The recording tape cartridge according to claim 3, wherein edge portions that slant linearly from the center side of the reel toward the outer peripheral side of the reel are formed on the reel side of the unit ribs.

5 . The recording tape cartridge according to claim 4, wherein angles formed by the unit ribs that are mutually adjacent are configured to be equal.

6. A recording tape cartridge comprising:
a reel that includes flanges that extend substantially parallel and around which is wound recording tape between the flanges; and
a case that includes mutually opposing inner surfaces and rotatably houses the reel between the inner surfaces, with plural ribs whose height gradually becomes lower from a center-of-rotation side of the reel toward an outer peripheral side of the reel being formed on at least one of the inner surfaces.

7. The recording tape cartridge according to claim 6, wherein the ribs are configured by a plurality of ribs with the same shape that extend radially from a center-of-rotation side of the reel and are separated by substantially equal angles.

8. The recording tape cartridge according to claim 6, wherein edge portions of the ribs on the side of the ribs that faces the reel are linear, and angles that the edge portions form with a plane that is perpendicular to an axis of rotation of the reel are equal to or less than 2 degrees.
